(19) United States
(12) Patent Application Publication
(10) Pub. No.: US 2019/0294973 A1
(43) Pub. Date: Sep. 26, 2019

(54) CONVERSATIONAL TURN ANALYSIS NEURAL NETWORKS

(71) Applicant: Google LLC, Mountain View, CA (US)

(72) Inventors: Anjuli Patricia Kannan, Berkeley, CA (US); Kai Chen, San Bruno, CA (US); Alvin Rishi Rajkomar, San Jose, CA (US)

(21) Appl. No.: 16/363,891

(22) Filed: Mar. 25, 2019

Related U.S. Application Data
(60) Provisional application No. 62/647,585, filed on Mar. 23, 2018.

(51) Int. Cl. G06N 3/08; G06N 3/04; G06F 17/27

(52) U.S. Cl. CPC G06N 3/088; G06F 17/2765; G06N 3/0454

(57) ABSTRACT

Methods, systems, and apparatus, including computer programs encoded on computer storage media, for training conversational turn analysis neural networks. One of the methods includes obtaining unsupervised training data comprising a plurality of dialogue transcripts; training a turn prediction neural network to perform a turn prediction task on the unsupervised training data using unsupervised learning, wherein: the turn prediction neural network comprises (i) a turn encoder neural network and (ii) a turn decoder neural network; obtaining supervised training data; and training a supervised prediction neural network to perform a supervised prediction task on the supervised training data using supervised learning.

### CROSS-REFERENCE TO RELATED APPLICATION

This application claims priority to U.S. Provisional Application No. 62/647,585, filed on Mar. 23, 2018. The disclosure of the prior application is considered part of and is incorporated by reference in the disclosure of this application.

### BACKGROUND

This specification relates to training neural networks that analyze conversational data that includes one or more conversational turns.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step. An example of a recurrent neural network is a long short term (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

This specification describes a system implemented as computer programs on one or more computers in one or more locations that trains a supervised prediction neural network. The supervised prediction neural network is a neural network that is configured to process dialogue data that includes a sequence of one or more conversational turns in order to perform a supervised prediction task, i.e., to make a prediction that relates to the input dialogue data.

Particular embodiments of the subject matter described in this specification can be implemented so as to realize one or more of the following advantages.

By pre-training an encoder neural network as described in this specification, the performance of a trained supervised prediction neural network that includes the encoder neural network is improved. Additionally, because the pre-training is performed using unsupervised learning, the amount of supervised training data necessary to train the supervised prediction neural network to effectively perform the supervised prediction task is minimized. That is, the supervised prediction neural network can be effectively trained even when limited supervised, i.e., labeled, training data is available. Thus, the training of the supervised prediction neural network is less data intensive and requires fewer computational resources than conventional approaches that do not pre-train the encoder neural network as described in this specification.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a diagram illustrating an example supervised prediction task that the supervised prediction neural network can perform.

FIG. 3 is a flow diagram of an example process for training the supervised prediction neural network and the turn prediction neural network.

FIG. 4 is a flow diagram of an example process for training the supervised prediction neural network.

Like reference numbers and designations in the various drawings indicate like elements.

### DETAILED DESCRIPTION

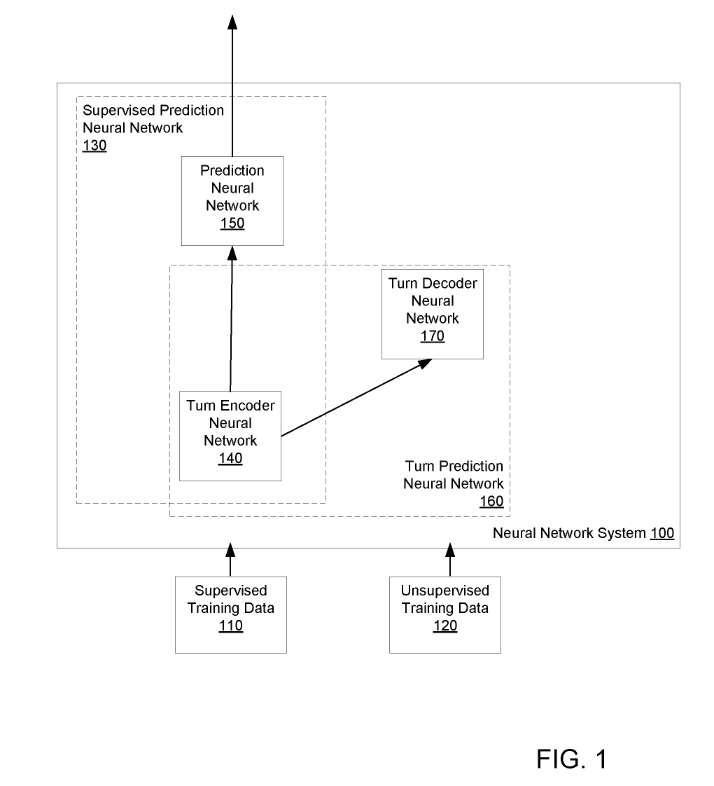

FIG. 1 shows an example neural network system 100. The neural network system 100 is an example of a system implemented as computer programs on one or more computers in one or more locations, in which the systems, components, and techniques described below can be implemented.

The neural network system 100 trains a supervised prediction neural network 130 to perform a supervised prediction task using supervised training data 110. The supervised prediction neural network 130 is a neural network that is configured to process dialogue data that includes a sequence of one or more conversational turns (referred to in this specification as a “snippet”) in order to perform the supervised prediction task, i.e., to make a prediction that relates to the input dialogue data.

The input dialogue data is data from a transcript of a dialogue between two or more participants, i.e., people or computer-implemented conversational agents. For example, the dialogue can be a medical conversation, e.g., a conversation between a patient and a doctor or other healthcare provider or an insurance company. As another example, the dialogue can be a conversation between a customer and a company representative, e.g., a sales call, a customer support call, and so on. As another example, the dialogue can be a conversation between two friends using a messaging or video conferencing service.

Generally, the supervised prediction task is a task to extract information from the dialogue. The type of information to be extracted can vary depending on the nature of the dialogue and of the supervised prediction task.

In the medical context, in some cases the task may be to annotate the dialogue to generate a medical-specific record of the conversation.

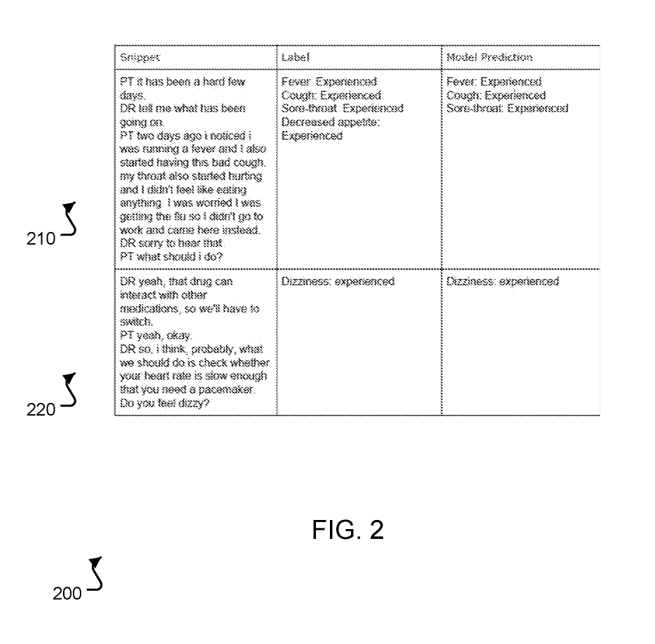

In some of these cases, the medical-specific record may be a physician's note and the supervised prediction may be a prediction of whether a given input conversational snippet is discussing a symptom and, if so, which symptom is being discussed and the status of the symptom (i.e., whether the patient has experienced the symptom or the symptom is irrelevant to the patient, i.e., was just mentioned in passing or in a context that shows that it has no relevance to the medical condition of the patient). Optionally, the supervised prediction may also predict the values of certain properties of the symptom, e.g., the severity of the symptom or how long the patient has been experiencing the symptom. An example of this supervised prediction task is discussed in more detail below with reference to FIG. 2.

In others of these cases, the medical-specific record may be patient instructions and the supervised prediction may be a prediction of whether a given input snippet is discussing instructions for the patient and, if so, characteristics of the discussed instructions.

In yet others of these cases, the medical-specific record may document reimbursable activities that occurred during a patient visit and the supervised prediction task may be to identify whether a given snippet refers to the occurrences of a reimbursable activity and, if so, which reimbursable activity.

Examples of neural network architectures that include an encoder neural network as described below and types of supervised prediction tasks are described in U.S. patent application Ser. No. 15/362,643, filed on Nov. 28, 2016, the entire contents of which are hereby incorporated herein by reference.

Once the trained supervised prediction neural network 130 has generated a prediction for a given input snippet, the prediction of the neural network 130 can be added to electronic medical-specific record data for the patient that participated in the dialogue, e.g., added to an electronic medical record for the patient.

More specifically, the supervised prediction neural network 130 includes (i) a turn encoder neural network 140 and (ii) a prediction neural network 150.

The turn encoder neural network 140 is configured to receive an input conversational turn and to generate an encoded representation of the input conversational turn in accordance with a set of encoder network parameters.

The prediction neural network 150 is configured to receive respective encoded representations of each conversational turn in an input snippet of one or more conversational turns generated by the turn encoder neural network and to process the respective encoded representations in accordance with a set of prediction network parameters to generate a supervised prediction for the input snippet.

Depending on the nature of the supervised prediction task, the prediction neural network 150 can be, e.g., a recurrent neural network, a recurrent neural network augmented with an attention mechanism, a self-attention-based decoder neural network, or a convolutional neural network.

As a particular example, the encoder neural network 140 can be a recurrent neural network that processes the tokens in each conversational turn in the snippet in the order in which the turns occur in the dialogue to generate the encoded representations, and the prediction neural network 150 can be a decoder recurrent neural network that autoregressively generates the supervised prediction by attending over the encoded representations.

To configure the supervised prediction neural network 130 to effectively perform the supervised prediction task, the system 100 trains the neural network 130 on supervised training data 110. The supervised training data 110 includes a plurality of input snippets and, for each input snippet, a ground truth output (also known as a “label”) that identifies the output that should be generated by the neural network 130 by processing the input snippet. Examples of labels for an example supervised prediction task are described below with reference to FIG. 2.

However, the amount of supervised training data available to system 100 can in many cases be relatively small. For example, a large amount of dialogue data, i.e., transcriptions of spoken dialogues between patient and doctor, may be available because the transcriptions can be generated automatically from the recordings of conversation. However, only a small fraction of the input snippets in the dialogue data may be labelled, because determining an accurate label for an input snippet requires review of the audio or of the transcript by a domain expert. Thus, large quantities of unlabeled data may be available but only a small subset of that data is able to be used for supervised training of the neural network 130.

To mitigate this issue and in order to improve the training, prior to training the supervised prediction neural network 130, the system 100 trains a turn prediction neural network 160 to perform a turn prediction task on unsupervised training data 120 using unsupervised learning. This training of the turn prediction neural network 160 will generally be referred to as “pre-training.”

The unsupervised training data 120 includes dialogue data and, in turn, input snippets derived from the dialogue data. The unsupervised training data 120 is referred to as unsupervised data because labels for the supervised prediction task are not available for the input snippets in the dialogue data or are not used during the unsupervised training. For example, the unsupervised training data 120 can include the input snippets in the supervised training data 110 (but without the corresponding labels from the data 110) and additional unlabeled dialogue data. Thus, the unsupervised training data 120 generally includes a much larger number of input snippets than are included in the supervised training data 110.

The turn prediction neural network 160 includes (i) the turn encoder neural network 140, i.e., the same turn encoder neural network that is part of the supervised prediction neural network 130 and (ii) a turn decoder neural network 170 that is configured to receive an encoded representation of the input conversational turn and to process the encoded representation to generate a turn prediction.

The turn prediction task is a task that does not require an external label outside of what is in the input dialogue data. In particular, the turn prediction task is a task that requires, for a given input snippet, a prediction of a conversational turn or a snippet that is in a particular position in the dialogue data relative to the input snippet.

For example, the turn prediction task may be to auto-encode the input snippet and the turn prediction therefore is a predicted reconstruction of the input snippet.

As another example, the turn prediction task may be to predict one or more turns that immediately follow the input snippet in a dialogue transcript and the turn prediction therefore is a prediction of one or more turns that follow the input snippet in the dialogue transcript in which the input snippet is found.

As another example, the turn prediction task may be to predict the turns that are at one or more predetermined positions relative to the input snippet in a dialogue transcript, and the turn prediction therefore is a prediction of the turns that are at the one or more predetermined positions relative to the input snippet turn in the dialogue transcript in which the input snippet is found.

More specifically, as part of training the turn prediction neural network 160, the system trains the turn encoder neural network 140 to determine updated values of the encoder network parameters from initial values of the encoder network parameters and trains the turn decoder neural network 170 to determine updated values of the turn decoder network parameters from initial values of the turn decoder network parameters.

For the purposes of training the supervised prediction neural network 130, the system 100 then initializes the values of the turn encoder network parameters to the updated values determined during the training of the turn prediction neural network 160. That is, training the supervised prediction neural network 130 to perform the supervised prediction task includes training the turn prediction neural network to determine trained values of the encoder network parameters from the updated values of the encoder network parameters that were determined by training the turn prediction neural network 160 on the turn prediction task.

FIG. 2 is a diagram 200 illustrating an example supervised task that the supervised prediction neural network 130 can be configured to perform. In particular, the diagram 200 shows two example inputs (“snippets”) to the neural network 130, the label for each input in the supervised training data, and the supervised prediction (“model prediction”) generated by the neural network 130 for each input during training.

In particular, in the example of FIG. 2, the supervised prediction neural network 130 is configured to receive a snippet that includes one or more conversational turns from a dialogue between a patient (“PT”) and a doctor (“DR”). In the particular example of FIG. 2, each snippet includes five conversational turns. While the example of FIG. 2 has a snippet length of five turns, the snippet length can be shorter or longer, e.g., as short as one turn or as long as ten or twenty turns.

In the example of FIG. 2, the supervised prediction neural network 130 is configured to predict any symptoms that are discussed in the input snippet and the status of each snippet (e.g., “experienced” by the patient, “not experienced” by the patient, or “irrelevant” to the patient). For example, for the snippet 210, the neural network has predicted that the snippet discussed fever, cough, and sore-throat, and that the patient experienced all of these symptoms. As can be seen from the label for the snippet 210, the neural network should have also predicted that the symptom “decreased appetite” was discussed and that the symptom was experienced by the patient.

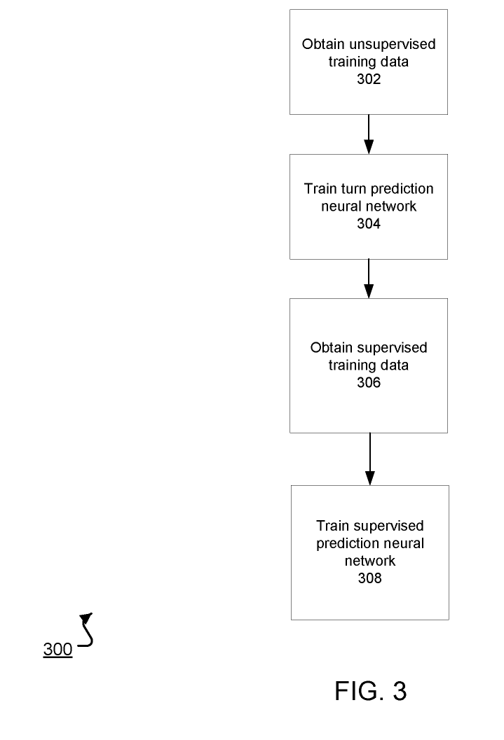

FIG. 3 is a flow diagram of an example process 300 for training the turn prediction neural network and the supervised prediction neural network. For convenience, the process 300 will be described as being performed by a system of one or more computers located in one or more locations. For example, a neural network system, e.g., the neural network system 100 of FIG. 1, appropriately programmed, can perform the process 300.

The system receives unsupervised training data (step 302). The unsupervised training data includes a set of dialogue transcripts, each of which includes a sequence of conversational turns. The training data is referred to as “unsupervised” training data because no labels for the dialogue transcripts are available or, if labels for some of the conversational turns are available, these labels are not used when training on the unsupervised training data.

The system trains the turn prediction neural network on the unsupervised training data to perform the turn prediction task (step 304). In particular, the system trains the turn prediction neural network to perform the turn prediction task by training the turn encoder neural network to determine updated values of the encoder network parameters from initial values of the encoder network parameters and to train the turn decoder neural network to determine updated values of the encoder network parameters from initial values of the turn decoder network parameters.

In particular, the system trains these two neural networks jointly by backpropagating gradients of an unsupervised learning objective function, i.e., a function that measures the performance of the neural network on the unsupervised task, through the turn decoder neural network and into the turn encoder neural network and then updating the parameter values using the gradients. This can be done using any appropriate unsupervised learning technique, e.g., gradient descent using the Adam optimizer, the rmsProp optimizer, or the SGD update rule.

The system obtains supervised training data (step 306). The supervised training data includes input snippets and, for each input snippet, a label for the supervised prediction task. For example, the supervised training data may be the subset of the snippets in the unsupervised training data that have been labelled.

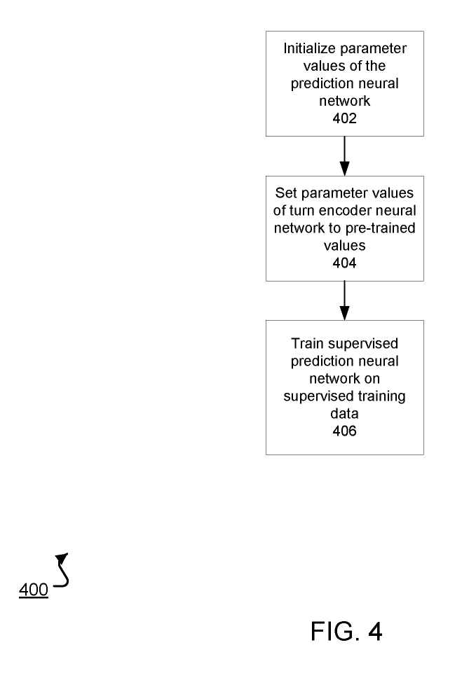

The system trains the supervised prediction neural network on the supervised training data (step 308). This training will be described in more detail below with reference to FIG. 4.

FIG. 4 is a flow diagram of an example process for training the supervised prediction neural network. For convenience, the process 400 will be described as being performed by a system of one or more computers located in one or more locations. For example, a neural network system, e.g., the neural network system 100 of FIG. 1, appropriately programmed, can perform the process 400.

The system initializes the parameter values of the prediction neural network (step 402). For example, the system can initialize the parameter values randomly by sampling from a specified distribution or can initialize the parameter values to pre-determined values. In particular, because the prediction neural network has not previously been trained, the system does not use the results of any training when initializing the parameter values.

The system sets the parameter values of the turn encoder neural network to the pre-trained values determined as a result of the unsupervised training of the turn prediction neural network (step 404). In other words, the system sets the parameter values of the turn encoder neural network to the updated values of the parameters after the turn encoder neural network has been trained as part of the unsupervised training described above with reference to step 304.

The system trains the supervised prediction neural network on the supervised training data using supervised learning (step 406) to determine (i) trained values of the encoder network parameters from the updated, i.e., pre-trained, values of the encoder network parameters that were determined by training the turn prediction neural network on the turn prediction task and (ii) trained values of the prediction neural network parameters from the initialized values of the prediction neural network parameters.

In particular, the system trains these two neural networks jointly by backpropagating gradients of a supervised learning objective function, i.e., a function that measures the performance of the neural network on the supervised prediction task, through the prediction neural network and into the turn encoder neural network and then updating the parameter values using the gradients. This can be done using any appropriate supervised learning technique, e.g., gradient descent using the Adam optimizer, the rmsProp optimizer, or the SGD update rule.

Once the supervised prediction neural network has been trained, the system can provide data specifying the trained network, e.g., the trained values of the parameters and data defining the architecture of the neural network, to another system for use in performing the supervised prediction task. Alternatively or in addition, the system can begin using the trained neural network to perform the supervised prediction task on newly received inputs.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining unsupervised training data comprising a plurality of dialogue transcripts, each dialogue transcript comprising a sequence of conversational turns;
training a turn prediction neural network to perform a turn prediction task on the unsupervised training data using unsupervised learning, wherein:
the turn prediction neural network comprises (i) a turn encoder neural network that is configured to receive an input snippet comprising one or more input conversational turns and to generate an encoded representation of the input snippet in accordance with a set of encoder network parameters and (ii) a turn decoder neural network that is configured to receive the encoded representation of the input snippet and to process the encoded representation to generate a turn prediction, and
training the turn prediction neural network to perform the turn prediction task comprises training the turn encoder neural network to determine updated values of the encoder network parameters from initial values of the encoder network parameters;
obtaining supervised training data comprising a plurality of snippets of one or more conversational turns and, for each snippet, a respective target output; and
training a supervised prediction neural network to perform a supervised prediction task on the supervised training data using supervised learning, wherein:
the supervised prediction neural network comprises (i) the turn encoder neural network and (ii) a prediction neural network that is configured to receive the encoded representation of the input snippet generated by the turn encoder neural network and to process the respective encoded representations to generate a supervised prediction, and
training the supervised prediction neural network to perform the supervised prediction task comprises training the turn prediction neural network to determine trained values of the encoder network parameters from the updated values of the encoder network parameters that were determined by training the turn prediction neural network on the turn prediction task.

2. The method of claim 1, wherein the turn prediction task is to auto-encode the input snippet, and wherein the turn prediction is a predicted reconstruction of the input snippet.

3. The method of claim 1, wherein the turn prediction task is to predict one or more turns that follow the input snippet in a dialogue transcript, and wherein the turn prediction is a prediction of a turn that follows the input snippet in the dialogue transcript in which the input snippet is found.

4. The method of claim 1, wherein the turn prediction task is to predict the turns that are at one or more predetermined positions relative to the input snippet in a dialogue transcript, and wherein the turn prediction is a prediction of the turns that are at the one or more predetermined positions relative to the input snippet in the dialogue transcript in which the input snippet is found.

5. The method of claim 1, wherein the prediction neural network has a set of prediction parameters, and wherein training the supervised prediction neural network to perform the supervised prediction task comprises training the prediction neural network jointly with the encoder neural network to determine trained values of the prediction network parameters from initial values of the prediction network parameters.

6. The method of claim 5, wherein the prediction neural network has not been previously trained on any other task before the supervised prediction neural network is trained on the supervised prediction task.

7. The method of claim 1, wherein the encoder neural network is a recurrent neural network that is configured to process each turn in the snippet to generate the encoded representation.

8. The method of claim 1, wherein the conversational turns in the supervised training data are a proper subset of the conversational turns in the unsupervised training data.

9. The method of claim 1, further comprising:
providing the supervised prediction neural network for use in performing the supervised prediction task.

10. A system comprising one or more computers and one or more storage devices storing instructions that, when executed by the one or more computers, cause the one or more computers to perform operations comprising:
obtaining unsupervised training data comprising a plurality of dialogue transcripts, each dialogue transcript comprising a sequence of conversational turns;
training a turn prediction neural network to perform a turn prediction task on the unsupervised training data using unsupervised learning, wherein:
the turn prediction neural network comprises (i) a turn encoder neural network that is configured to receive an input snippet comprising one or more input conversational turns and to generate an encoded representation of the input snippet in accordance with a set of encoder network parameters and (ii) a turn decoder neural network that is configured to receive the encoded representation of the input snippet and to process the encoded representation to generate a turn prediction, and
training the turn prediction neural network to perform the turn prediction task comprises training the turn encoder neural network to determine updated values of the encoder network parameters from initial values of the encoder network parameters;
obtaining supervised training data comprising a plurality of snippets of one or more conversational turns and, for each snippet, a respective target output; and
training a supervised prediction neural network to perform a supervised prediction task on the supervised training data using supervised learning, wherein:
the supervised prediction neural network comprises (i) the turn encoder neural network and (ii) a prediction neural network that is configured to receive the encoded representation of the input snippet generated by the turn encoder neural network and to process the respective encoded representations to generate a supervised prediction, and
training the supervised prediction neural network to perform the supervised prediction task comprises training the turn prediction neural network to determine trained values of the encoder network parameters from the updated values of the encoder network parameters that were determined by training the turn prediction neural network on the turn prediction task.

11. The system of claim 10, wherein the turn prediction task is to auto-encode the input snippet, and wherein the turn prediction is a predicted reconstruction of the input snippet.

12. The system of claim 10, wherein the turn prediction task is to predict one or more turns that follow the input snippet in a dialogue transcript, and wherein the turn prediction is a prediction of a turn that follows the input snippet in the dialogue transcript in which the input snippet is found.

13. The system of claim 10, wherein the turn prediction task is to predict the turns that are at one or more predetermined positions relative to the input snippet in a dialogue transcript, and wherein the turn prediction is a prediction of the turns that are at the one or more predetermined positions relative to the input snippet in the dialogue transcript in which the input snippet is found.

14. The system of claim 10, wherein the prediction neural network has a set of prediction parameters, and wherein training the supervised prediction neural network to perform the supervised prediction task comprises training the prediction neural network jointly with the encoder neural network to determine trained values of the prediction network parameters from initial values of the prediction network parameters.

15. The system of claim 14, wherein the prediction neural network has not been previously trained on any other task before the supervised prediction neural network is trained on the supervised prediction task.

16. The system of claim 10, wherein the encoder neural network is a recurrent neural network that is configured to process each turn in the snippet to generate the encoded representation.

17. The system of claim 10, wherein the conversational turns in the supervised training data are a proper subset of the conversational turns in the unsupervised training data.

18. The system of claim 10, the operations further comprising:
providing the supervised prediction neural network for use in performing the supervised prediction task.

19. One or more non-transitory computer-readable storage media encoded with instructions that, when executed by one or more computers, cause the one or more computers to perform operations comprising:
obtaining unsupervised training data comprising a plurality of dialogue transcripts, each dialogue transcript comprising a sequence of conversational turns;
training a turn prediction neural network to perform a turn prediction task on the unsupervised training data using unsupervised learning, wherein:
the turn prediction neural network comprises (i) a turn encoder neural network that is configured to receive an input snippet comprising one or more input conversational turns and to generate an encoded representation of the input snippet in accordance with a set of encoder network parameters and (ii) a turn decoder neural network that is configured to receive the encoded representation of the input snippet and to process the encoded representation to generate a turn prediction, and
training the turn prediction neural network to perform the turn prediction task comprises training the turn encoder neural network to determine updated values of the encoder network parameters from initial values of the encoder network parameters;
obtaining supervised training data comprising a plurality of snippets of one or more conversational turns and, for each snippet, a respective target output; and
training a supervised prediction neural network to perform a supervised prediction task on the supervised training data using supervised learning, wherein:
the supervised prediction neural network comprises (i) the turn encoder neural network and (ii) a prediction neural network that is configured to receive the encoded representation of the input snippet generated by the turn encoder neural network and to process the respective encoded representations to generate a supervised prediction, and
training the supervised prediction neural network to perform the supervised prediction task comprises training the turn prediction neural network to determine trained values of the encoder network parameters from the updated values of the encoder network parameters that were determined by training the turn prediction neural network on the turn prediction task.

20. The computer-readable storage media of claim 19, wherein the conversational turns in the supervised training data are a proper subset of the conversational turns in the unsupervised training data.
